(19) United States
(12) Patent Application Publication
(10) Pub. No.: US 2025/0283508 A1
(43) Pub. Date: Sep. 11, 2025

(54) BEARING UNIT WITH RETENTION CAGE

(71) Applicant: AKTIEBOLAGET SKF, GOTEBORG (SE)

(72) Inventors: Piero SANTANGELO, Torino (IT); Federico DAL ZILIO, None (IT); Salvatore CERASUOLO, Pinerolo (IT); Alessio NEBBIA COLOMBA, Pisa (IT)

(21) Appl. No.: 19/062,161

(22) Filed: Feb. 25, 2025

(30) Foreign Application Priority Data
Mar. 8, 2024 (IT) 102024000005245

(51) Int. Cl. F16C 33/38

(52) U.S. Cl. CPC F16C 33/3887

(57) ABSTRACT

A bearing unit includes a radially outer ring, a radially inner ring, and a retention cage configured to retain a plurality of rolling bodies between the radially outer ring and the radially inner ring. The retention cage includes a one-piece annular body having a plurality of radially extending pockets each configured to retain one of the plurality of rolling bodies, and each of the plurality of pockets is bounded by a pocket surface. The pocket surface includes a plurality of convex portions and a plurality of concave portions and is bounded by an inner imaginary cylinder and a concentric outer imaginary cylinder. The convex portions are tangent to or extend in part along the inner imaginary circle, and the concave portions are tangent to or extend in part along the outer imaginary circle.

### CROSS-REFERENCE

This application claims priority to Italian patent application no. 102024000005245 filed on Mar. 8, 2024, the contents of which are fully incorporated herein by reference.

### TECHNOLOGICAL FIELD

The present disclosure relates to a bearing unit with a retention cage. In particular, the bearing unit is an angular-contact bearing unit for applications requiring high precision, for example machine tools.

### BACKGROUND

Known bearing units with a retention cage include a radially outer ring, a radially inner ring, a plurality of rolling bodies, in particular balls, interposed between the inner ring and the outer ring to enable the relative rotation thereof, and a retention cage, which holds the balls in respective circumferential positions. The retention cage of a known type comprises a one-piece annular body that defines a reference axis, the body of the cage delimiting substantially cylindrical cavities or pockets distributed about the reference axis. The balls are housed in these cavities, which define the positioning and holding of the balls.

These retention cages are frequently used in high-velocity, high-vibration bearing units, in particular for applications in the industrial sector, for example in machine tool spindles, and are typically made by injection molding a polymer material, including to compensate for poor lubrication conditions. As the bearing unit requires a high degree of precision, the cages for these applications must also meet this accuracy requirement. Therefore, the cages are finished with machine tools and must therefore have a very simple geometry.

The main drawback of this type of retention cage is the amount of friction that occurs between the balls and their cavities due to the cylindrical geometry of the portion of the cavity in contact with the balls.

### SUMMARY

An aspect of the present disclosure is to provide a bearing unit with a retention cage that does not have the drawback described above.

Another aspect of the disclosure comprises a bearing unit having a central rotation axis, a radially outer ring, a radially inner ring and a retention cage configured to retain a plurality of rolling bodies between the radially outer ring and the radially inner ring. The retention cage is centered on the radially outer ring and includes a one-piece annular body having a plurality of radially extending cavities each configured to retain one of the plurality of rolling bodies. Each of the plurality of cavities is bounded by a cavity surface, and the cavity surfaces include a plurality of convex portions and a plurality of concave portions. The cavity surface is bounded by an inner imaginary cylinder and a concentric outer imaginary cylinder, and the convex portions are tangent to or extend in part along the inner imaginary circle and the concave portions are tangent to or extend in part along the outer imaginary circle.

In another aspect of the disclosure, the outer imaginary cylinder of each of the cavities is conceptually divided into four quadrants by an equatorial plane perpendicular to a circumferential direction and including the central rotational axis and a polar plane perpendicular to the equatorial plane.

In a further aspect of the disclosure, a first set of three of the convex portions is located on a first side of the equatorial plane and a second set of three of the convex portions is located symmetrically on a second side of the equatorial plane.

In yet another aspect of the disclosure, the polar plane intersects a first convex portion and a second convex portion, a third convex portion is located between the first convex portion and the equatorial plane on a first side of the polar plane and a fourth convex portion is located between the first convex portion and the equatorial plane on a second side of the polar plane, and a fifth convex portion is located between the second convex portion and the equatorial plane on the first side of the polar plane and a sixth convex portion is located between the second convex portion and the equatorial plane on the second side of the polar plane.

### BRIEF DESCRIPTION OF THE DRAWINGS

Embodiments of the invention are described below with reference to the attached drawings, which show non-limiting example embodiments.

FIG. 1 is an axonometric view of a first embodiment of a bearing unit according to the present disclosure.

FIG. 2 is an axonometric view of a retention cage of the bearing unit of FIG. 1.

FIG. 3 shows a detail of the retention cage in FIG. 2.

### DETAILED DESCRIPTION

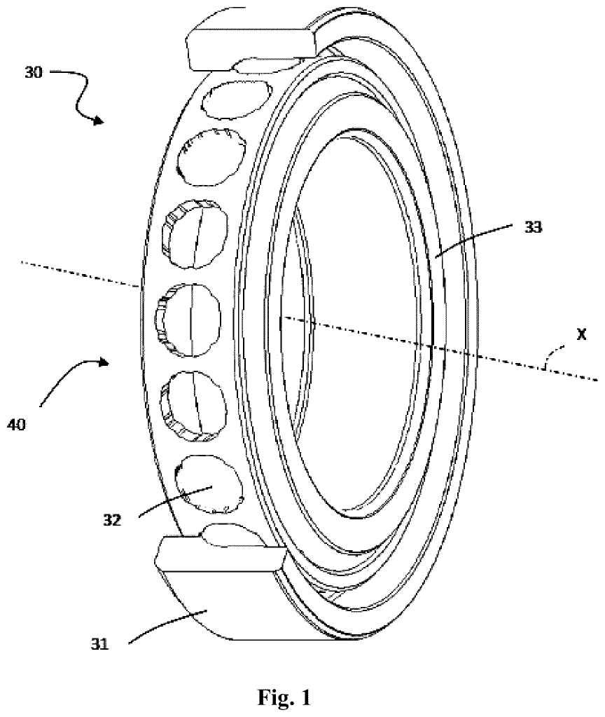

In FIG. 1, reference sign 30 denotes a bearing unit as a whole, according to a preferred embodiment of the disclosure. The bearing unit 30 has a central rotation axis X and comprises a stationary radially outer ring 31, a rotary radially inner ring 33, a row of rolling bodies 32, in particular balls, interposed between the radially outer ring 31 and the radially inner ring 33, and a cage 40 holding the rolling bodies 32 in place, the cage being centered on the radially outer ring 31.

Throughout the present description and in the claims, terms and expressions indicating positions and orientations, such as “radial” and “axial”, are to be understood with reference to the central rotation axis X of the bearing unit 30, unless otherwise specified. For the sake of simplicity, the term “ball” may be used by way of example in the present description and in the attached drawings instead of the more generic term “rolling body,” and the same reference signs shall be used.

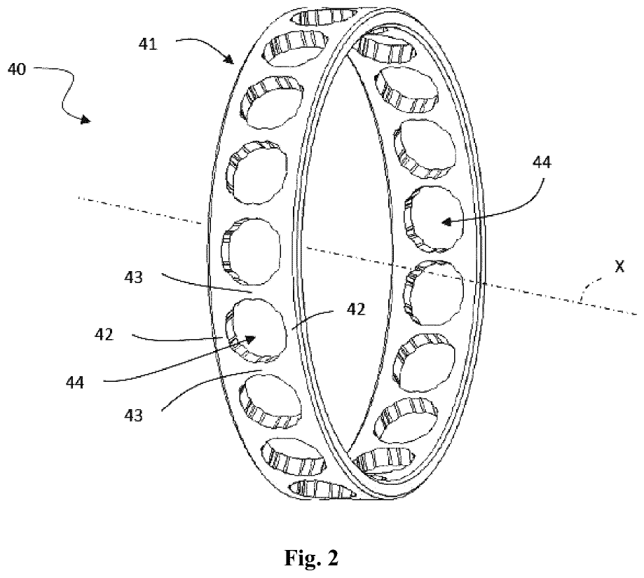

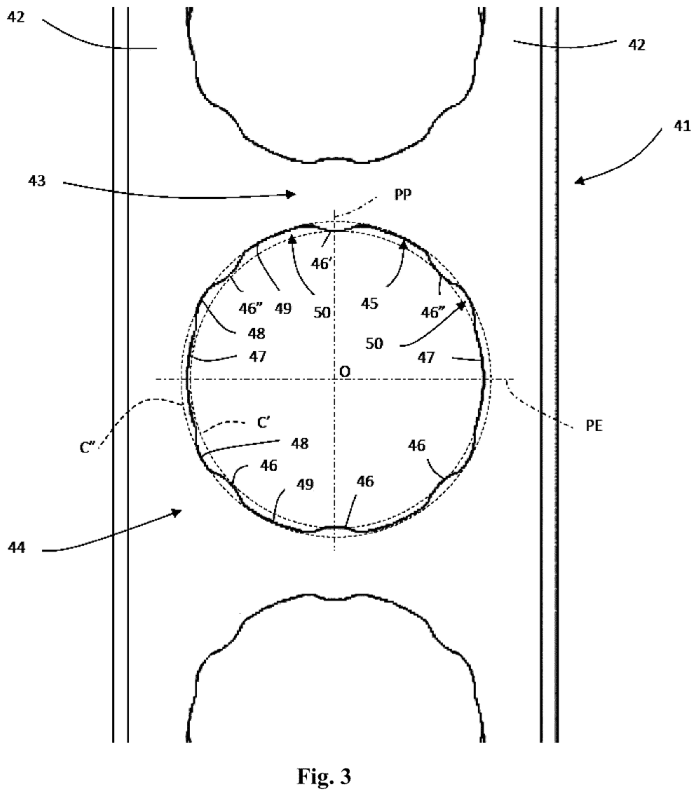

With reference to FIGS. 2 and 3, the cage 40 has an annular shape defining a main axis of inertia or reference axis, which is coincident with the central rotation axis X of the bearing unit 30. The retention cage 40 has a one-piece annular body 41 that forms two rings 42 connected by bridges 43. The annular body 41 of the cage 40 can be made of any suitable material, in particular any material suitable for additive manufacturing, for example plastic, ceramic or metal material. An example of a material preferably used is a composite material based on cotton fibers impregnated with a phenolic resin.

The two rings 42 and the bridges 43 delimit a plurality of cavities or pockets 44 separated by the bridges 43 and each framed by the two rings 42. A radially outer surface 45 of the cavity 44 delimits the boundary of the cavity 44 with respect to the two rings 42 and the pair of bridges 43 that define one particular pocket. The cavities 44 house respective rolling bodies 32, in particular balls, in order to position and hold the rolling bodies.

Each cavity 44 has a polar plane PP and an equatorial plane PE, both perpendicular to the annular body 41. Each cavity 44 has a center O at the intersection of these two planes. The centers O of the cavities 44 are all located at an equal distance from the central rotation axis X.

The radially outer surface 45 of each cavity 44 has an innovative shape specifically configured to reduce friction between the rolling bodies and the cavities and also to enable better distribution of the lubricating grease. In particular, the novel shape of the surface 45 of the cavity 44 comprises a plurality of waves 46, 46′, 46″ or curvilinear surface portions that are convex towards the center O of the cavity 44 and tangent to a cylindrical surface C′ inside the surface 45 of the cavity 44. According to a preferred embodiment, there are six waves 46, 46′, 46″ located symmetrically about the equatorial plane PE. Preferably, the three waves 46′, 46″ located in a first half-space with respect to the equatorial plane PE are angularly separated from each other by 45°. In particular, one wave 46′ is located on the polar plane PP and the other two waves 46″ are symmetrical about the polar plane PP. The 45° angle between two consecutive waves has been defined by topological optimization. In other words, it is a process based on a design to build the cage by 3D printing, reducing the material therein to achieve the most efficient result. Evidently, the same ratios as described above also apply to the three waves 46 located in a second half-space with respect to the equatorial plane, given the symmetry of the waves about the equatorial plane PE. The waves 46, 46′, 46″ act as contact surfaces with the respective ball 32 fitted in the cavity 44 and are the only contact surfaces between the ball and the cavity. This marked reduction of the contact surfaces reduces friction and therefore reduces heat generation.

Curvilinear sections 47 are arranged along the equatorial plane PE and symmetrical about the polar plane PP. Again, these sections are curvilinear surface portions facing each other on both sides of the equatorial plane PE. The curvilinear sections 47 are therefore formed on the rings 42 of the annular body 41 of the cage 40, are concave towards the center O of the cavity 44, and are tangent to (or lie on) the cylindrical surface C′ inside the surface 45 of the cavity 44. The two curvilinear sections 47 are intended to increase the rigidity of the cage along the equatorial plane PE of the cavity 44, increasing the cross-section of the two rings 42. This prevents concentrations of stress in this zone. The two sections 47 also act as guides for the ball within the cavity 44.

First arcuate surface portions 48 and second arcuate surface portions 49 are located between two waves 46, 46′, 46″ and between a wave 46 and a curvilinear section 47, respectively. The second arcuate surface portions 49 are longer than the first arcuate surface portions 48. These arcuate surface portions 48, 49 are concave towards the center O of the cavity 44 and are tangent to (or lie on) second cylindrical surface C″ outside the surface 45 of the cavity 44. The first arcuate surface portions 48 and the second arcuate surface portions 49 define chambers 50 between the ball 32 and the cage 40 used as reservoirs for containing the lubricating grease. These chambers 50 are used to hold the grease and to release the grease during the rotation of the ball, such that the balls and raceways of the rings 31, 33 of the bearing unit 30 are always lubricated, avoiding metal-on-metal contact between the ball and the raceways. In addition, the lubrication reservoirs are also used to lubricate the contact between the cavity and the ball, reducing friction between these components.

Advantageously, the contact points between the waves 46, 46′, 46″ and the arcuate surface portions 48, 49 and between the second arcuate surface portions 49 and the curvilinear sections 47 are appropriately rounded to remove sharp edges and consequently eliminate/reduce stress in the material under static and dynamic conditions.

Therefore, it can be concluded that the cavity 44 has a radially outer surface 45 that has alternating curvilinear surface portions and is substantially enclosed within two cylindrical surfaces C′, C″ that are concentric about the center O of the cavity 44.

Although the invention is applicable to any method of manufacturing the bearing unit cage, given the particular geometry of the cage, as described above, the aforementioned invention is particularly suitable for a bearing unit cage in which the body is obtained by additive manufacturing.

Ultimately, the present disclosure provides the following advantages: 1) the entire cage can be obtained using a known injection molding process or, preferably, using other processes such as additive manufacturing, 2) the geometry of the outer surface of the cavities allows the contact surfaces between the rolling body and the cavity to be reduced, thereby reducing friction, 3) some of the internal spaces of the cavity are designed to create reservoirs for retaining the lubricant, and 4) consequently, the lubrication between the balls and the raceways (on the outer and inner rings) is optimized by the lubrication reservoirs described above.

Numerous other variants exist in addition to the embodiments of the invention described above. The embodiments are provided solely by way of example and do not limit the scope of the invention, its applications or its possible configurations. Indeed, although the description provided above enables the person skilled in the art to carry out the present invention at least according to one example configuration thereof, numerous variations of the components described could be used without thereby departing from the scope of the invention, as defined in the attached claims.

What is claimed is:

1. A bearing unit having a central rotation axis and comprising:
a radially outer ring,
a radially inner ring,
a retention cage configured to retain a plurality of rolling bodies between the radially outer ring and the radially inner ring, the retention cage being centered on the radially outer ring and comprising:
a one-piece annular body having a plurality of radially extending pockets each configured to retain one of the plurality of rolling bodies, each of the plurality of pockets being bounded by a pocket surface,
wherein the pocket surface includes a plurality of convex portions and a plurality of concave portions, the pocket surface being bounded by an inner imaginary cylinder and a concentric outer imaginary cylinder, and
wherein the convex portions are tangent to or extend in part along the inner imaginary circle and the concave portions are tangent to or extend in part along the outer imaginary circle.

2. The bearing unit according to claim 1,
wherein the convex portions are configured to contact the rolling body in the pocket.

3. The bearing unit according to claim 1,
wherein the outer imaginary cylinder of each of the pockets is conceptually divided into four quadrants by an equatorial plane perpendicular to a circumferential direction and including the central rotational axis and a polar plane perpendicular to the equatorial plane

4. The bearing unit according to claim 3,
wherein a first set of three of the convex portions is located on a first side of the equatorial plane and a second set of three of the convex portions is located symmetrically on a second side of the equatorial plane.

5. The bearing unit according to claim 3,
wherein the polar plane intersects a first convex portion and a second convex portion,
wherein a third convex portion is located between the first convex portion and the equatorial plane on a first side of the polar plane and a fourth convex portion is located between the first convex portion and the equatorial plane on a second side of the polar plane, and
wherein a fifth convex portion is located between the second convex portion and the equatorial plane on the first side of the polar plane and a sixth convex portion is located between the second convex portion and the equatorial plane on the second side of the polar plane.

6. The bearing unit according to claim 5,
wherein the third, fourth, fifth and sixth convex portions are evenly circumferentially spaced from each other.

7. The bearing unit according to claim 5,
wherein a first portion of the pocket surface lines on the inner imaginary cylinder and is intersected by the equatorial plane on the first side of the polar plane, and
wherein a second portion of the pocket surface lies on the inner imaginary cylinder and is intersected by the equatorial plane on the second side of the polar plane.

8. The bearing unit according to claim 7,
wherein a third portion of the pocket surface lies on the outer imaginary cylinder between the first convex portion and the third convex portion and a fourth portion of the pocket surface lies on the outer imaginary cylinder between the first convex portion and the fourth convex portion.

9. The bearing unit according to claim 8,
wherein a fifth portion of the pocket surface lies on the outer imaginary cylinder between the third convex portion and the first portion of the pocket surface, and
wherein a sixth portion of the pocket surface lies on the outer imaginary cylinder between the fourth convex portion and the second portion of the pocket surface.

10. The bearing unit according to claim 9,
wherein the first portion of the pocket surface is longer than the third portion of the pocket surface.

11. The bearing unit according to claim 9,
wherein at least one of the concave portions is filled with grease.

12. The bearing unit according to claim 9,
wherein the annular body of the cage is formed by an additive manufacturing process.

13. The bearing unit according to claim 9,
wherein the annular body is formed from cotton fibers impregnated with a phenolic resin.

14. The bearing unit according to claim 1,
wherein the annular body is formed from cotton fibers impregnated with a phenolic resin.
